(19) United States
(12) Patent Application Publication
(10) Pub. No.: US 2025/0249845 A1
(43) Pub. Date: Aug. 7, 2025

(54) FIRE BARRIER ARRANGEMENT AND HYBRID ELECTRIC VEHICLE INCLUDING THE SAME

(71) Applicant: PHINIA Jersey Holdings LLC, Wilmington, DE (US)

(72) Inventors: Luis Manuel Porras Morales, Ciudad Juarez (MX); Hector Rene Mendoza Pedrozo, Ciudad Juarez (MX)

(21) Appl. No.: 18/435,309

(22) Filed: Feb. 7, 2024

(51) Int. Cl. B60R 13/08

(52) U.S. Cl. CPC B60R 13/083

(57) ABSTRACT

A fire barrier arrangement for arresting propagation of fire to a fuel tank of a hybrid electric vehicle is provided. The fire barrier arrangement includes a fuel line for transporting fuel from a fuel tank to an internal combustion engine, the fuel line defining a fluid pathway for fuel in a flow direction from the fuel tank to the internal combustion engine. The arrangement further includes a battery pack, and a first check valve disposed in the fuel line along the fluid pathway. The first check valve is disposed either upstream or downstream of the battery pack along the fluid pathway of the fuel line. The first check valve allows flow of fuel in the flow direction but restricts flow of fuel in a direction opposite the flow direction, whereby the first check valve is a fire barrier that arrests propagation of fire along the fuel line.

### FIELD OF THE INVENTION

The disclosure generally relates to fire safety in motor vehicles, and more particularly to fire safety in hybrid electric vehicles including a battery pack and a source of flammable fuel.

### BACKGROUND OF THE INVENTION

Electric vehicles (EVs) including hybrid electric vehicles (HEVs) utilize a battery such as a lithium-ion battery as an energy source for a motor that drives the movement of the vehicle. The batteries used in electric vehicles are susceptible to being defective, overcharged, or overheated, thermal runaway may occur in which the temperature of the battery increases rapidly to a point anywhere in a range of 250° C. to 1000° C. During thermal runaway, the battery may ignite into fire, which puts the occupants of the vehicle, rescuers, and innocent by-standers in danger. This danger is further exacerbated in hybrid electric vehicles that additionally include an internal combustion engine that operates using a flammable fuel such as gasoline or diesel. Spread of a battery fire from the battery to the flammable fuel stored in a source of fuel such as an onboard fuel tank presents an additional hazard. Therefore, a need exists for safety measures to isolate a fuel tank from a vehicle battery and/or to reduce the propagation of a battery fire in a hybrid electric vehicle from the battery to the fuel source.

### BRIEF SUMMARY

A fire barrier arrangement for arresting propagation of fire to a fuel tank of a hybrid electric vehicle is provided. The fire barrier arrangement includes a fuel line for transporting fuel from a fuel tank to an internal combustion engine, the fuel line defining a fluid pathway for fuel in a flow direction from the fuel tank to the internal combustion engine. The arrangement further includes a battery pack, and a first check valve disposed in the fuel line along the fluid pathway. The first check valve is disposed either upstream or downstream of the battery pack along the fluid pathway of the fuel line. The first check valve allows flow of fuel in the flow direction but restricts flow of fuel in a direction opposite the flow direction, whereby the first check valve is a fire barrier that arrests propagation of fire along the fuel line.

In specific embodiments, the first check valve is disposed between the battery pack and the fuel tank along the fluid pathway.

In specific embodiments, a second check valve is disposed in the fuel line. The first check valve is disposed upstream of the battery pack along the fluid pathway of the fuel line and between the battery pack and the fuel tank, and the second check valve is disposed downstream of the battery pack along the fluid pathway of the fuel line and between the battery pack and the internal combustion engine.

In specific embodiments, the first check valve is proximate the battery pack.

In specific embodiments, the first check valve is spaced a distance from the battery pack.

In particular embodiments, one or both of the first and second check valves are proximate the battery pack.

In particular embodiments, one or both of the first and second check valves are spaced a distance from the battery pack.

A motor vehicle is also provided. The motor vehicle includes an internal combustion engine and a fuel tank for storing a source of fuel for the internal combustion engine. A fuel line connects the fuel tank to the internal combustion engine. The fuel line defines a fluid pathway for fuel in a flow direction from the fuel tank to the internal combustion engine. At least one check valve is disposed in the fuel line along the fluid pathway. The at least one check valve allows flow of fuel in the flow direction but restricts flow of fuel in a direction opposite the flow direction, whereby the at least one check valve is a fire barrier that arrests propagation of fire along the fuel line towards the fuel tank.

In specific embodiments, the motor vehicle is a hybrid electric vehicle further comprising a battery pack.

In particular embodiments, the motor vehicle includes one check valve disposed either upstream or downstream of the battery pack along the fluid pathway of the fuel line.

In particular embodiments, the motor vehicle includes one check valve disposed between the battery pack and the fuel tank along the fluid pathway.

In particular embodiments, the motor vehicle includes including two check valves. One of the check valves is disposed upstream of the battery pack along the fluid pathway of the fuel line, and the other of the check valves is disposed downstream of battery pack.

In certain embodiments, the one check valve is disposed between the battery pack and the internal combustion engine, and the other check valve is disposed between the battery pack and the fuel tank.

In particular embodiments, the at least one check valve is proximate the battery pack.

In particular embodiments, the at least one check valve is spaced a distance from the battery pack.

A method of arresting propagation of a battery fire to a source of fuel in a hybrid electric vehicle is also provided. The method includes providing a first check valve in a fuel line of a hybrid electric vehicle, the fuel line defining a fluid pathway for fuel in a flow direction from a fuel tank to an internal combustion engine of the hybrid electric vehicle. The method further includes disposing the first check valve along the fluid pathway of the fuel line upstream of a battery pack of the hybrid electric vehicle. The first check valve allows flow of fuel in the flow direction but restricts flow of fuel in a direction opposite the flow direction, whereby the first check valve is a fire barrier that arrests propagation of fire along the fuel line towards fuel in the fuel tank and reduces a quantity of fuel exposed to a battery pack fire.

In specific embodiments, the first check valve is disposed between the battery pack and the fuel tank along the fluid pathway.

In specific embodiments, the method further includes providing a second check valve in the fuel line, disposing the first check between the battery pack and the fuel tank along the fluid pathway of the fuel line, and disposing the second check valve downstream of the battery pack along the fluid pathway of the fuel line and between the battery pack and the internal combustion engine.

In specific embodiments, the first check valve is one of: (i) proximate the battery pack; or (ii) spaced a distance from the battery pack.

In particular embodiments, each of the first check valve and the second check valve is one of: (i) proximate the battery pack; or (ii) spaced a distance from the battery pack.

### DESCRIPTION OF THE DRAWINGS

Various advantages and aspects of this disclosure may be understood in view of the following detailed description when considered in connection with the accompanying drawings, wherein:

FIG. 1 is a schematic view of a fire barrier arrangement for a vehicle in accordance with some embodiments of the disclosure; and

FIG. 2 is a schematic view of a fire barrier arrangement for a vehicle in accordance with other embodiments of the disclosure.

### DETAILED DESCRIPTION OF THE INVENTION

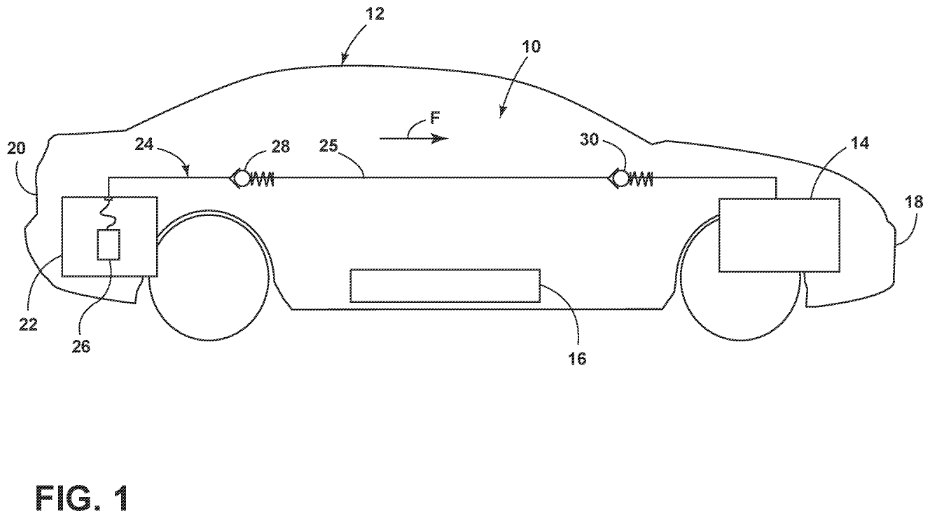

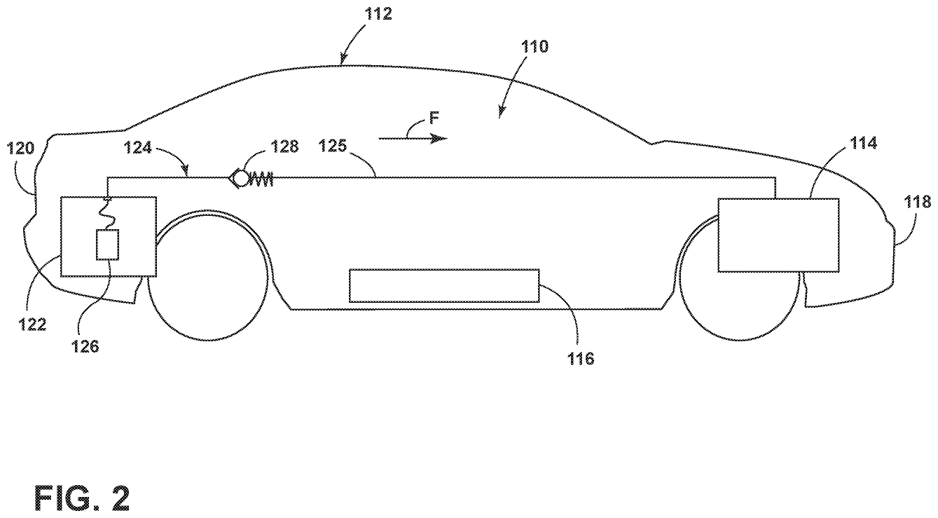

A fire barrier arrangement for arresting propagation of fire to a fuel tank of a hybrid electric vehicle is provided, and a motor vehicle including the fire barrier arrangement, are provided. Referring to FIGS. 1 and 2, wherein like numerals indicate corresponding parts throughout the several views, the fire barrier arrangement is illustrated and generally designated as 10, 110. The fire barrier arrangement 10, 110 arrests (slows or stops) the propagation of a battery pack fire to the fuel tank and/or engine in a motor vehicle 12 and thereby provides for fire safety in the event of a battery pack fire.

With reference first to FIG. 1, the motor vehicle 12 may be but is not limited to an automotive vehicle, such as an internal combustion engine (ICE) vehicle or more particularly a hybrid electric vehicle (HEV) including both an internal combustion engine 14 and a battery pack 16 for powering the vehicle. The motor vehicle may have any of the general features of an ICE or HEV as known in the art. For example, the motor vehicle 12 may include a body (shown to have a generic body design in the schematic drawings) having a front end 18 and a rear end 20. The vehicle 12 body shown in the drawings is merely for illustrative purposes, and the relative sizes of the vehicle and its components are not necessarily to scale and are shown schematically for indication of the relative positions of the following components in relation to the front 18 and rear 20 of the vehicle 12 as well as to each other in the vehicle. The battery pack 16 is generally disposed in the middle of the body between the front and rear ends 18, 20, and also generally on the bottom or lower portion of the body underneath the cabin area of the vehicle. The battery pack 16 includes a plurality of individual battery cells (or a plurality of battery modules each including a plurality of battery cells) that store electrical energy and are capable of being charged and discharged. The vehicle 12 also includes a fuel tank 22 that stores a supply of combustible fuel (e.g., gasoline or diesel fuel) that is burned by an internal combustion engine 14 to produce power. For example, in a hybrid electric vehicle, mechanical power generated by the internal combustion engine 14 (by combusting fuel) may be converted into electricity that is stored in the battery pack 16, thereby charging the battery cells of the battery pack. In turn, the battery cells are discharged to power an electric motor (not shown) that drives the wheels of the vehicle. Typically, the internal combustion engine 14 is disposed towards the front end 18 of the body, while the fuel tank 22 is disposed towards the rear end 20 of the body, with the battery pack 16 in between. As such, the fuel line 24 (conduit/hose/pipe for delivering fuel from the fuel tank 22 to the engine 14) connecting the fuel tank 22 to the engine 14 traverses a distance from the rear 20 of the vehicle 12 to the front 18 of the vehicle and passes by the battery pack 16. A fuel pump 26 located in the fuel tank 22 pumps fuel through the fuel line 24 along a fluid pathway 25 from the fuel tank 22 to the internal combustion engine 14, and hence combustible fluid is pumped along the fluid pathway 25 in a flow direction F from the fuel tank 22, past the battery pack 16, and to the internal combustion engine 14 during operation of the vehicle.

The fire barrier arrangement 10 includes the fuel line 24 and the battery pack 16. The arrangement 10 further includes one or more check valves 28, 30 disposed in and connected in-line with the fuel line along the fluid pathway 25. The check valve(s) by design automatically (without external control) allow for one-way flow of fuel in the fuel line in the flow direction F from the fuel tank 22 to the engine 14, but restrict and/or prevent flow of fuel in a backwards direction opposite to the direction of fuel flow F from tank to engine. In the arrangement 10 shown in FIG. 1, a first check valve 28 is disposed upstream of the battery pack 16 in the flow direction F and hence is disposed between and in a position that is intermediate the battery pack 16 and the fuel tank 22. The first check valve 28 therefore may be at any position between the battery pack 16 and the fuel tank 22. A second check valve 30 is disposed downstream of the battery pack 16 in the flow direction F and hence is disposed between and in a position that is intermediate the battery pack 16 and the internal combustion engine 14. The second check valve 30 therefore may be at any position between the battery pack 16 and the internal combustion engine 14. As such, the first check valve 28 may be generally on an opposite side of the battery pack 16 from the second check valve 30. The first and/or second check valves 28, 30 may be proximate the battery pack 16, i.e. nearby or in the general vicinity of the battery pack but adjacent or just to the sides of the battery pack along the fluid pathway 25. Alternatively, the first and/or second check valves 28, 30 may be spaced a distance from the battery pack 16 such that there is a gap between the first check valve 28 and the battery pack 16 along the fluid pathway 25 of the fuel line 24, and likewise a gap between the second check valve 30 and the battery pack 16 along the fluid pathway 25 of the fuel line 24. The distance may be on the order of inches, a foot, or on the order of feet, such as, for example, 6 inches, a foot, 1.5 feet, 2.0 feet, 3.0 feet, at least 6 inches, at least one foot, at least 1.5 feet, at least 2.0 feet, at least 3.0 feet, and the like.

In case of battery fire, the fire may spread to the portion of the fuel line 24 that traverses across the vicinity of the battery pack 16. Fuel in the fuel line, being flammable, may be ignited by the battery fire. The fire may then travel along the fluid pathway 25 as the fuel is ignited, particularly from the vicinity of the battery pack 16 towards the fuel in the fuel tank 22. However, the check valve 28 provides a barrier in the fuel line 24 and prevents the fire from passing and blocks any further amount of fuel from being introduced to the fire. Further, the check valve 28 thereby prevents the fire from reaching the fuel tank 22 via the fuel line 24 and hence reduces the amount of fuel that is exposed to the battery fire. Likewise, the check valve 30 provides a barrier in the fuel line 24 and prevents the fire from travelling in the fuel line from the vicinity of the battery pack 16 towards the engine 14. The check valve 30 thus prevents fuel from igniting the engine on fire via the fuel line 24.

In an alternative arrangement 110 shown in FIG. 2, only one check valve 128 is provided in the vehicle 112 and this check valve is disposed upstream of the battery pack 116 in the flow direction F and hence is disposed between the battery pack 116 and the fuel tank 122 along the fluid pathway 125 of the fuel line 124 between the front end 118 and the rear end 120 of the vehicle. Fuel is pumped by the fuel pump 126 in the flow direction F, but the check valve 128 blocks the fluid pathway 125 in a direction opposite to the flow direction F. The check valve 128 thereby prevents a battery fire from reaching the fuel tank 122 through the fuel line 124, but does not itself prevent fire from travelling forward along the fuel line to the engine 114. In yet another alternative arrangement not shown, the arrangement may include only one check valve that is disposed downstream of the battery pack in the flow direction and hence is disposed between the battery pack and the internal combustion engine, opposite to what is shown in FIG. 2.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements by ordinal terms, for example “first,” “second,” and “third,” are used for clarity, and are not to be construed as limiting the order in which the claim elements appear. Any reference to claim elements in the singular, for example, using the articles “a,” “an,” “the” or “said,” is not to be construed as limiting the element to the singular.

What is claimed is:

1. A fire barrier arrangement for arresting propagation of fire to a fuel tank of a hybrid electric vehicle, the fire barrier arrangement comprising:
a fuel line for transporting fuel from a fuel tank to an internal combustion engine, the fuel line defining a fluid pathway for fuel in a flow direction from the fuel tank to the internal combustion engine;
a battery pack;
a first check valve disposed in the fuel line along the fluid pathway, the first check valve being disposed either upstream or downstream of the battery pack along the fluid pathway of the fuel line;
wherein the first check valve allows flow of fuel in the flow direction but restricts flow of fuel in a direction opposite the flow direction, whereby the first check valve is a fire barrier that arrests propagation of fire along the fuel line.

2. The fire barrier arrangement of claim 1, wherein the first check valve is disposed between the battery pack and the fuel tank along the fluid pathway.

3. The fire barrier arrangement of claim 1, including a second check valve disposed in the fuel line, wherein the first check valve is disposed upstream of the battery pack along the fluid pathway of the fuel line and between the battery pack and the fuel tank, and the second check valve is disposed downstream of the battery pack along the fluid pathway of the fuel line and between the battery pack and the internal combustion engine.

4. The fire barrier arrangement of claim 1, wherein the first check valve is proximate the battery pack.

5. The fire barrier arrangement of claim 1, wherein the first check valve is spaced a distance from the battery pack.

6. The fire barrier arrangement of claim 3, wherein one or both of the first and second check valves are proximate the battery pack.

7. The fire barrier arrangement of claim 3, wherein one or both of the first and second check valves are spaced a distance from the battery pack.

8. A motor vehicle comprising:
an internal combustion engine;
a fuel tank for storing a source of fuel for the internal combustion engine;
a fuel line connecting the fuel tank to the internal combustion engine, the fuel line defining a fluid pathway for fuel in a flow direction from the fuel tank to the internal combustion engine;
at least one check valve disposed in the fuel line along the fluid pathway;
wherein the at least one check valve allows flow of fuel in the flow direction but restricts flow of fuel in a direction opposite the flow direction, whereby the at least one check valve is a fire barrier that arrests propagation of fire along the fuel line towards the fuel tank.

9. The motor vehicle of claim 8, wherein the motor vehicle is a hybrid electric vehicle further comprising a battery pack.

10. The motor vehicle of claim 9, including one said check valve disposed either upstream or downstream of the battery pack along the fluid pathway of the fuel line.

11. The motor vehicle of claim 9, including one said check valve disposed between the battery pack and the fuel tank along the fluid pathway.

12. The motor vehicle of claim 9, including two said check valves, wherein one of the check valves is disposed upstream of the battery pack along the fluid pathway of the fuel line, and the other of the check valves is disposed downstream of battery pack.

13. The motor vehicle of claim 12, wherein said one of the check valves is disposed between the battery pack and the internal combustion engine, and said other of the check valves is disposed between the battery pack and the fuel tank.

14. The motor vehicle of claim 9, wherein the at least one check valve is proximate the battery pack.

15. The motor vehicle of claim 9, wherein the at least one check valve is spaced a distance from the battery pack.

16. A method of arresting propagation of a battery fire to a source of fuel in a hybrid electric vehicle, the method comprising:
providing a first check valve in a fuel line of a hybrid electric vehicle, the fuel line defining a fluid pathway for fuel in a flow direction from a fuel tank to an internal combustion engine of the hybrid electric vehicle;
disposing the first check valve along the fluid pathway of the fuel line upstream of a battery pack of the hybrid electric vehicle;
wherein the first check valve allows flow of fuel in the flow direction but restricts flow of fuel in a direction opposite the flow direction, whereby the first check valve is a fire barrier that arrests propagation of fire along the fuel line towards fuel in the fuel tank and reduces a quantity of fuel exposed to a battery pack fire.

17. The method of claim 16, wherein the first check valve is disposed between the battery pack and the fuel tank along the fluid pathway.

18. The method of claim 16, further comprising:
providing a second check valve in the fuel line;
disposing the first check between the battery pack and the fuel tank along the fluid pathway of the fuel line; and
disposing the second check valve downstream of the battery pack along the fluid pathway of the fuel line and between the battery pack and the internal combustion engine.

19. The method of claim 16, wherein the first check valve is one of: (i) proximate the battery pack; or (ii) spaced a distance from the battery pack.

20. The method of claim 18, wherein each of the first check valve and the second check valve is one of: (i) proximate the battery pack; or (ii) spaced a distance from the battery pack.
